(19) United States
(12) Patent Application Publication
(10) Pub. No.: US 2012/0163620 A1
(43) Pub. Date: Jun. 28, 2012

(54) Method for communicating with a portable device having audio output

(76) Inventor: Michael Weibin Zhang, Yuen Long (HK)

(21) Appl. No.: 13/329,499

(22) Filed: Dec. 19, 2011

Related U.S. Application Data
(60) Provisional application No. 61/460,132, filed on Dec. 27, 2010.

(51) Int. Cl. H04B 5/00

(52) U.S. Cl. 381/79

(57) ABSTRACT

A short range communication method for transmitting data from a host device to an accessory device with certain embodiments involves at the host device, an application software package associated with the accessory device generating an encoded audio signal to drive a loudspeaker of the host device; at the accessory device, a sensor module located near the loudspeaker receiving the encoded audio signal using inductive coupling, a processing module decoding the audio signal to recover the data.

### CROSS REFERENCE TO RELATED APPLICATIONS

This application is based on and claims the priority of provisional patent application No. U.S. 61/460,132 filed Dec. 27, 2010.

### TECHNICAL FIELD

The present invention relates to short range communication systems. More particularly, the present invention relates to short range inductively coupled communication systems between a portable host device and its accessory device.

### BACKGROUND

Modern portable devices such as mobile phone, handheld computer, and portable media/music player are essentially computer systems with various interfaces. Many accessories are often built around a popular portable device such as the iPhone of Apple Inc to enhance the usage of the portable device. Some accessories incorporate electronic circuitries.

This kind of accessory device normally interfaces with the portable host device via a standard wireless connection such as IrDA, WIFI or BLUETOOTH, or with a standard wired connection such as USB, or with proprietary connectors. A typical accessory device is the BLUETOOTH earpiece that can provide hands-free operation for a mobile phone.

Wireless connections require complex circuitry and relatively high power consumption, adding the cost to the accessory. A wired connection requires a physical connector which increases the size of the accessory and creates inconveniences when reconnecting and disconnecting. Some portable devices only provide proprietary interfaces that require certification and licensing, increasing the cost and limiting the ability for interaction between the host device and the accessory.

There is a need for a communication mean between the host device and the accessory device that is light weight, low power consumption, low cost and yet reliable.

Inductive coupling, which is well known in the art, is a simple mean for short range communication. However most modern electronic devices have not been designed and made to use inductive coupling for communications. There is no built-in transmitter coil.

A widely used inductive audio coupling device is the telephone pickup coil that has been used to pick up audio signals from the transducer of the handset of a traditional telephone. The pickup coils are used for hands-free operation, telephone recording, monitoring, connecting with a modem, and spying. In these applications, because the telephone is not designed and made for transmitting data originated from the telephone to the pickup coil, only audio signal originated from the PSTN is transmitted and received up by the pickup coil. The audio signal is not altered by the telephone before being coupled to the pickup coil. Although the user can press the buttons on the telephone to generate DTMF and other tones to be received by the pickup coil, the information transmitted is very limited and slow. This can not be used as an effective communication mean between the telephone and the device using the pickup coil.

Inductive coupling has also been widely used in hearing assistive devices for communication between a signal source and a small hearing aid of the type worn behind the ear or in the ear. In most of the applications, called tele-coil, audio signal is transmitted in a non-modulated analog form, as described in U.S. Pat. No. 6,078,675. In other applications modulation is employed for improvement of quality, as described in U.S. Pat. No. 5,615,229. In these applications, the transmitter or both the transmitter and the receiver are designed specifically to use inductive coupling methods. The transmitter normally has at least one transmitter coil to transmit the signal.

It is desirable for an inductive coupling method to allow an accessory device to receive data effectively from an existing portable host device which has not been designed to use inductive coupling.

### SUMMARY OF THE INVENTION

The present invention provides a short range communication system from a host device to an accessory device using inductive coupling.

Most portable host devices have at least one built-in loudspeaker for audio output. The built-in loudspeaker is normally a moving-coil transducer. Although the original purpose of the loudspeaker is to produce sound, the moving-coil also produces an electromagnetic signal during its operation. The accessory device according to the present invention uses a sensor coil to receive the electromagnetic signal. As most modern electronic devices are essentially a computer system capable of installing and running third party software after the device is manufactured, an application software package designed for the accessory device is installed and run in the host device to encode the data to be transmitted as a sequence of sound signal to drive the built-in loudspeaker of the host device. The accessory device receives the signal and decodes the signal to recover the data. The data is used by the accessory device to function for its particular purposes. Working with the application software running on the host device, the accessory can enhance the functionality of the host device.

Because host devices are ready made products, the position and the maximum strength of the electromagnetic field of the loudspeaker are fixed for each model. The sensor coil of the accessory device related to the present invention is positioned closely to the loudspeaker to gain maximum signal strength in order to drive an amplifier with low power consumption.

The sensor coil and amplifier circuit can also receive normal audio signals such as voice, music, ring tone and alert sound that are generated by the host itself and feed it to a processing module for further processing. The processing module can be a CPU module that analyses the normal audio signal to produce particular control commands for the accessory. The processing module can also bypass the sound signal to the output module.

A protective case is a widely used accessory that is close to the host device. It is particularly suitable for the method of the present invention to be used in protective cases, bags, cradles, stands and other forms with embedded electronics. Because these accessories are touching or very close to the host device, the sensor coil can be placed very closely to the loudspeaker of the host device. So the signal has a high signal to noise ratio and is strong enough to drive an amplify circuit with low power consumption and gain, reducing costs and prolonging battery lives.

An accessory device for one way communication from the host device to the accessory device according to the present invention usually includes an inductive receiver module, a processing module, and an input/output module.

### BRIEF DESCRIPTION OF THE DRAWINGS

FIG. 1 is a block diagram showing the inductive coupling method of the present invention.

FIG. 2 is a circuit diagram of an amplifier

FIG. 3 is a block diagram showing the structure of a preferred embodiment for universal remote control application

FIG. 4 is a structure diagram showing the preferred embodiment for universal remote control application

FIG. 5 is a diagram showing the encoding method of a preferred embodiment for universal remote control application

FIG. 6 is a diagram showing the encoding method of a preferred embodiment for data transmission application using sound in the upper audible range of humans or ultrasound

### DETAILED DESCRIPTION OF THE INVENTION

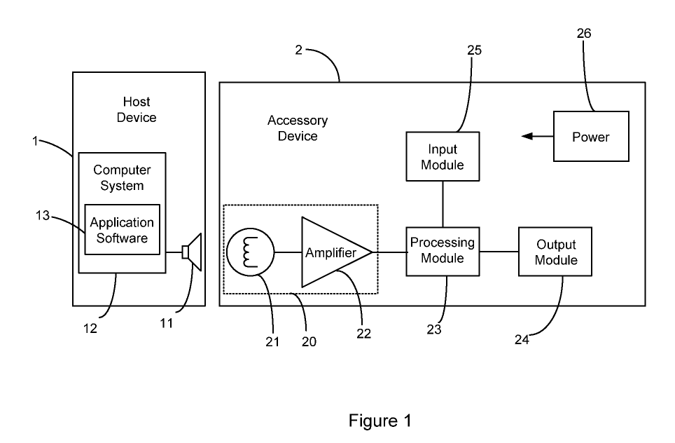

FIG. 1 describes the inductive coupling method of the present invention between host device 1 and accessory device 2. The host device 1 is a ready-made potable device that has not been designed originally to use inductive coupling. The host device 1 can be a mobile phone, an audio/video player, a portable gamming device, or a portable or tablet computer. The host device has at least one built-in loudspeaker 11. The host device 1 comprises a computer system 12 running a piece of application software 13 installed specifically for the accessory device 2. The accessory device 2 comprises an inductive receiver module 20, a processing module 23, an output module 24, an input module 25 and power module 26.

The inductive receiver module 20 further comprises a sensor coil 21, an amplifier circuit 22.

The built-in loudspeaker 11 of the host device 1 has been positioned at a fixed place inside the host device 1 during manufacturing. By arranging the relative position of the host device 1 and accessory device 2, the sensor coil 21 is placed near the loudspeaker 11 in order to receive the maximum amount of electromagnetic signal generated by the coil inside the loudspeaker 11.

To transmit data from the host device 1 to the accessory device 2, an application software program running on the computer system 12 of the host device 1 generates an encoded audio signal according to the data to be transmitted to drive the loudspeaker 11. The amplifier circuit 22 amplifies the signal received by the sensor coil 21 to an adequate magnitude and feeds it to the processing module 23. The processing module 23 decodes the data and uses the data for the entire system of the accessory 2.

The output module 24 and input module 25 work with the processing module 23 to perform the specific functions of the accessory 2. An example of the input module 25 comprises a switch. An example of the output module 26 comprises an infrared LED to transmit infrared remote control signal to other devices. Another example of the output module is an LCD screen that can display a digital clock or weather information.

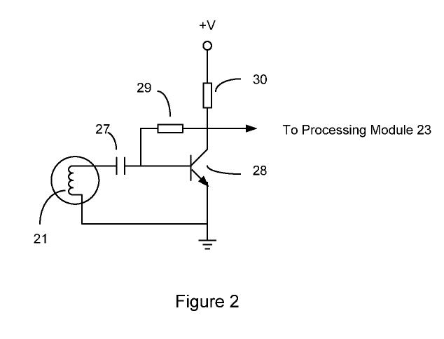

FIG. 2 describes an example of the amplifier circuit 22. The sensor coil 21 is coupled to a transistor 28 via a capacitor 27. Resistors 29 and 30 provide a very weak current to the transistor 28 to form an amplifier circuit of low power consumption. The magnitude of the output signal is high enough to wake up the processing module 23 in sleep mode.

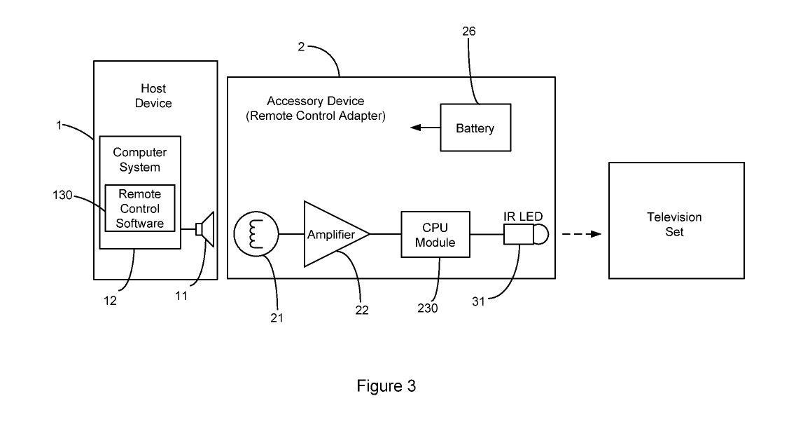

FIG. 3 describes a preferred embodiment of the present invention that is embedded in a protective case of a host device to form a universal remote control. Most smart mobile phone or portable music/video player can run third-party software called applications (or Apps). The remote control software 130 for this application has a user interface full of buttons which is similar to a real remote control unit. When the user presses a button on the user interface of the remote control software 130, the computer system 12 inside the host device 1 generates a corresponding encoded signal and outputs it to drive the loudspeaker 11. The sensor coil 21 receives the signal and feeds it to the CPU module 230 via the amplifier circuit 22. The CPU module 230 decodes the signal and recovers the code. The CPU module 230 generates a remote control signal according to the code to drive the infrared LED 31. The infrared signal then controls a TV or other devices.

The software can have infrared codes for various models of electronic home appliances, making the application a universal remote control.

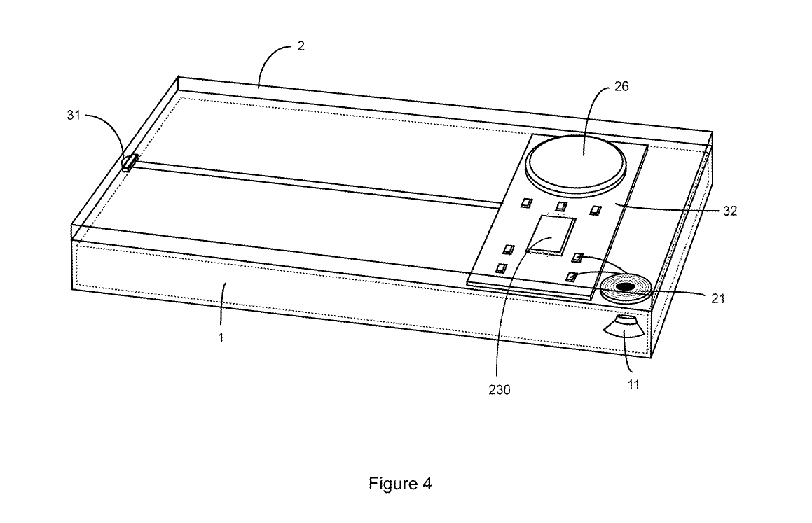

FIG. 4 describes the structure the preferred embodiment of the present invention as a universal remote control housed in a protective case of the host. For illustration purpose, the host device 1 in FIG. 4 is facing down. During its normal operation the host device 1 should be facing up. The accessory 2 comprises a housing that also functions as a protective case for the host device 1; a sensor coil 21; a circuit board 32 with a battery 26, a CPU module 230 and an amplifier circuit; and an infrared LED 31 as the output module. The loudspeaker 11 inside the host mobile phone 1 is at the bottom corner of the host 1. The sensor coil 21 is placed right on top of the loudspeaker 11.

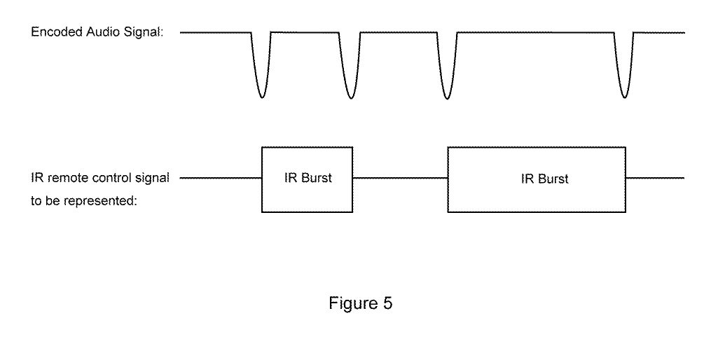

FIG. 5 describes one of the encoding schemes for the remote control application. An infrared remote control signal is a series of infrared bursts with variable length and intervals to represent ‘0’ or ‘1’ for transmission of binary codes. For the encoded audio signal, a pair of pulses represents the beginning and the end of each infrared burst. For example, odd pulses can signify the beginning of an infrared burst, and even pulses can signify the end of an infrared burst.

This encoding scheme is most suitable for real-time synchronized encoding or decoding of infrared remote control signal. It requires the CPU module to have relatively low processing power and storage space.

The pulses are normally audible in this encoding scheme, because the infrared coding frequency is within the range audible to human, although the carrier frequency of a normal infrared control signal is 38 KHz which is within the range of ultrasound. Some users may not like the noise.

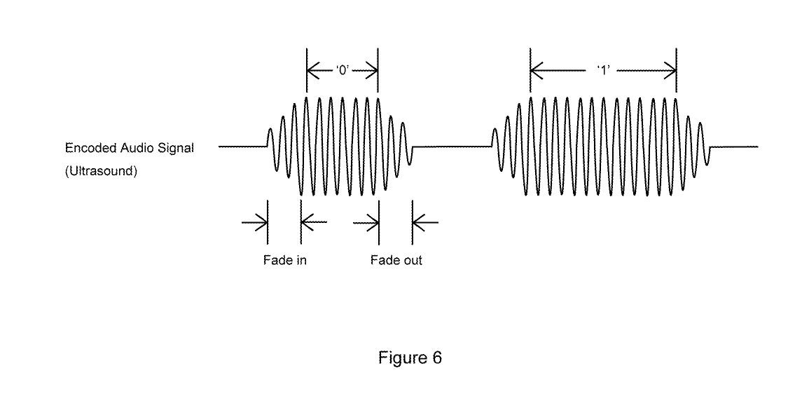

FIG. 6 describes an encoding method which is less audible. For hosts that can produce higher frequency signals above 20 KHz, ultrasound signal is used as the carrier. Binary ‘0’ and ‘1’ are represented by the different sequence, width and interval of the ultrasound bursts. At the beginning of each burst, fade-in modulation is applied. At the end of each burst, fade-out modulation is applied. With long enough fade-in and fade-out periods, the ultrasound bursts can hardly be heard by humans.

For a host that can not reproduce ultrasound, upper range of audible sound, with a frequency above 16 KHz, is used as the carrier.

The present invention may be embodied in other specific forms without departing from its spirit or essential characteristics. The described embodiments are to be considered in all respects only as illustrative and not restrictive.

What is claimed is:

1. An accessory device for an existing host device having not been designed or made to use inductive communication via its internal loudspeaker, comprising: a sensor module located close to said loudspeaker for receiving a transmitted signal in electromagnetic form from said loudspeaker using inductive coupling; a processing module connected with said sensor module for processing and recovering said transmitted signal; an output module connected with said processing module for carrying out particular functions of said accessory device according to said transmitted signal.

2. The accessory device according to claim 1, wherein said sensor module comprises a sensor coil for receiving said transmitted signal in electromagnetic form; and an amplifier circuit for amplifying said transmitted signal and feeding to said processing module.

3. The accessory device according to claim 1, wherein said processing module decodes said transmitted signal using a predefined encoding/decoding scheme to recover the original form of said transmitted signal.

4. The accessory device according claim 3, wherein a corresponding application software associated with said accessory device running in said host device generates an encoded audio signal using said encoding/decoding scheme to drive said internal loudspeaker to produce said transmitted signal; wherein said encoded audio signal is one or more of: a synchronized pulse signal; a modulated audio signal with carrier frequency range in sound, ultrasound and infrasound; a normal non-modulated audio signal.

5. The accessory device according to claim 4, wherein said output module comprises an infrared LED module for transmitting infrared remote control signals generated by said processing module according to said transmitted signal.

6. The accessory device according to claim 5, wherein said infrared remote control signal is represented by a number of infrared bursts of various lengths and intervals; wherein one of said synchronized pulse signals signifies the start of an infrared burst, and a subsequent of said synchronized pulse signals signifies the end of said infrared burst

7. The accessory device according to claim 4, wherein said modulated audio signal is applied with fade-in and fade-out during encoding.

8. The accessory device of an existing host device according to claim 1, comprises an input module connected to said processing module for accepting instructions from a user.

9. A short range communication system between a host device and an accessory device, wherein: said host device has not been designed and made for inductive coupling via its internal loudspeaker; said host device comprises a computer system capable of installing and running third party application software, an application software associated with said accessory device for generating an encoded audio signal, a loudspeaker for converting said encoded audio signal to an electromagnetic signal and transmitting said electromagnetic signal; said accessory device comprises a sensor module located close to said loudspeaker for receiving said transmitted signal using inductive coupling; a processing module connected with said sensor module for processing and decoding said transmitted signal; an output module connected with said processing module for carrying out particular functions of said accessory device according to said transmitted signal.

10. The system according claim 9, wherein said sensor module comprises a sensor coil for receiving said transmitted signal in electromagnetic form; and an amplifier circuit for amplifying said transmitted signal and feeding to said processing module.

11. The system according claim 9, wherein said application software associated with said accessory device running in said host device works with said input interface and said processing module to generate said encoded audio signal; wherein said encoded audio signal is one or more of: a synchronized pulse signal; a modulated audio signal with carrier frequency range in sound, ultrasound and infrasound; a normal non-modulated audio signal.

12. The system according claim 11, wherein said output module comprises an infrared LED module for transmitting infrared remote control signals generated by said processing module according to said transmitted signal.

13. The system according claim 11, wherein said infrared remote control signal is represented by a number of infrared bursts of various lengths and intervals; wherein one of said synchronized pulse signals signifies the start of an infrared burst, and a subsequent of said synchronized pulse signals signifies the end of said infrared burst.

14. The system according claim 11, wherein said modulated audio signal is applied with fade-in and fade-out during encoding.

15. A method for short range communication between a host device and an accessory device, wherein: said host device has not been designed and made for inductive coupling via its internal loudspeaker; said host device comprises a computer system capable of installing and running third party application software, an application software associated with said accessory device for generating an encoded audio signal according, a loudspeaker for converting said encoded audio signal to an electromagnetic signal and transmitting said electromagnetic signal; said accessory device comprises a sensor module located close to said loudspeaker for receiving said transmitted signal using inductive coupling; a processing module connected with said sensor module for processing and decoding said transmitted signal; an output module connected with said processing module for carrying out particular functions of said accessory device according to said transmitted signal.

16. The method according claim 15, wherein said sensor module comprises a sensor coil for receiving said transmitted signal in electromagnetic form; and an amplifier circuit for amplifying said transmitted signal and feeding to said processing module.

17. The method according claim 15, wherein said output module comprises an infrared LED module for transmitting infrared remote control signals generated by said processing module according to said transmitted signal.

18. The method according claim 17, wherein said infrared remote control signal is represented by a number of infrared bursts of various lengths and intervals; wherein one of said synchronized pulse signals signifies the start of an infrared burst, and a subsequent of said synchronized pulse signals signifies the end of said infrared burst.

19. The method according claim 17, wherein said modulated audio signal is applied with fade-in and fade-out during encoding.
